(19) United States
(12) Patent Application Publication
(10) Pub. No.: US 2005/0049958 A1
(43) Pub. Date: Mar. 3, 2005

(54) Supply chain data management

(75) Inventor: Laurie Macolino, Rockdale (AU)

Correspondence Address: DANA L. TANGREN, 1000 EAGLE GATE TOWER, 60 EAST SOUTH TEMPLE, SALT LAKE CITY, UT, 84111, US

(73) Assignee: Mercury Advisory Group Pty Ltd.

(21) Appl. No.: 10/788,430

(22) Filed: Feb. 27, 2004

(30) Foreign Application Priority Data
Aug. 29, 2003 (AU) 2003904675

(51) Int. Cl. G06F 17/60

(52) U.S. Cl. 705/37

(57) ABSTRACT

A supply chain data management system comprises a first trading entity (112) and at least one second trading entity (110) coupled to be in communication with a server (102) via a communications network, the first trading entity registered with the server as a participant of the system and the at least one second trading entity registered by the first trading entity as a trading partner of the first trading entity. A profile is associated with each said trading entity, which specifies supply chain data to be communicated to and/or from the trading entity. Each profile is accessible by the server, which automatically requests supply chain data from at least one of the trading entitles and in response to receiving the requested supply chain data, the server communicates data related to the supply chain data to one or more other of the trading entitles in accordance with their profile.

### FIELD OF THE INVENTIONS

The invention generally relates to the management of data in a supply chain. In particular, although not exclusively, the invention relates to a system, method and apparatus for supply chain data management that is compatible with existing business relationships, trading terms and internal systems and which provides improved supply chain data management efficiency.

### BACKGROUND TO THE INVENTION

In virtually every business there exists a supply chain that may comprise, for example, an input, a process and an output. In traditional industries, raw materials ordered from suppliers often constitute the input, the process may be a manufacturing process and the output may be a product manufactured from the raw materials. The end product is then delivered to, for example, a warehouse, a wholesaler or other customer. In service industries, services are provided to customers or clients rather than a product being manufactured, but there remains a supply chain comprising inputs of, for example, stationery and equipment, a process, such as the act of reserving holidays or analysing information, and outputs, such as the issuance of advice, tickets or the like.

Often the flow of information relating to the inputs, processes and outputs commences before there is a product in existence and the information flow does not cease until after delivery. In many instances after-sales service means that the information flow continues long after delivery.

Hence, there is usually a huge volume of information relating to the supply chain that requires careful and efficient management. In many businesses there are usually multiple supply chains, often hundreds or even thousands, which exacerbates the task of managing data associated with supply chains.

In today's business environment, the management of supply chain information such as customer details, purchase orders, delivery statuses, transportation dates and requirements and the like, is achieved with one or more computer systems employing many different applications.

One drawback of the current situation is that each business has its own Internal computer system that is different to, for example, both the internal system of its supplier and that of its customer. The incompatibility between the systems hinders or prevents the efficient exchange of supply chain information, which often results in time being wasted by employees in chasing up orders, checking deliveries, searching for and/or confirming information or the like.

Enabling communication between different internal systems of different organisations often requires expensive and time-consuming changes in internal software, business practices and/or trading terms. Even if this is carried out, businesses effecting the change often have to wait for their other trading partners and/or customers to also make the change before any improvement is experienced. Such delays can be costly and may never occur. Furthermore, even if new systems are introduced, efficiency is often hindered in the early stages whilst users become familiar with the new systems and procedures.

Hence, there is the need for a system, method and/or apparatus for managing supply chain information that at least ameliorates at least some of the aforementioned drawbacks of the prior art. In particular, there is a need for a system, method and/or apparatus that does not necessitate changes in the software of existing computing systems, business practices and/or trading terms and does not need all business partners to simultaneously join the system and/or method before the system and/or method becomes effective.

In this specification, the terms “comprises”, “comprising” or similar terms are intended to mean a nonexclusive inclusion, such that a method, system or apparatus that comprises a list of elements does not include those elements solely, but may well include other elements not listed.

### SUMMARY OF THE INVENTION

In one form, although it need not be the only or indeed the broadest form, the invention resides in a supply chain data management system comprising:
a first trading entity coupled to be in communication with a sever via a communications network, said first trading entity registered with said server as a participant of said system;
at least one second trading entity coupled to be in communication with said server via said communications network, said at least one second trading entity registered by said first trading entity as a trading partner of said first trading entity;
a profile associated with each said trading entity, said profile specifying supply chain data to be communicated to and/or from one or more of said trading entities, each profile accessible by said server;
wherein, said server automatically requests supply chain data from at least one of said trading entities and in response to receiving said requested supply chain data, said server communicates data related to said supply chain data to one or more other trading entities in accordance with their profile.

Preferably, each profile for each said second trading entity registered as a trading partner of said first trading entity is created by said first trading entity.

Preferably, said server informs said second trading entity via said communications network that they have been registered by said first trading entity following registration of said second trading entity by said first trading entity.

Preferably, each profile specifies a format of the supply chain data to be communicated to and/or from said trading entity.

Preferably, a predetermined time limit for responding to said request for supply chain data is associated with said request, after the expiry of which, if said server has not received said requested supply chain data, a reminder is sent by said server to said trading entity from which said supply chain data was requested.

Suitably, said data related to said supply chain data comprises a notification that supply chain data is available via said communications network, the availability of said data to said one or more of said second trading entities being specified by said first trading entity in said profile of said second trading entities.

Preferably, said supply chain data is communicated by email, electronic data interchange (EDI) or facsimile.

Preferably, the server is an application server.

In another form, the invention resides in a method of managing supply chain data in a system comprising a plurality of trading entities coupled to be in communication with a server via a communications network, said method including the steps of:
registering with said server at least one second trading entity as a trading partner of a first trading entity,
creating a profile associated with each said trading entity, each said profile specifying supply chain data to be communicated to and/or from one or more of said trading entities, each profile accessible by said server;
automatically requesting supply chain data from at least one of said trading entities; and
in response to said server receiving said requested supply chain data, communicating data related to said supply chain data to one or more other of said trading entities in accordance with their profile.

The method may further include specifying a format in which each trading entity receives said data related to said supply chain.

Preferably, the method further includes the step of said server informing said second trading entity via said communications network that they have been registered as a trading partner of said first trading entity by said first trading entity.

The method preferably further includes the steps of:
specifying a predetermined time limit for responding to said request for supply chain data; and
sending a reminder from said server to said trading entity from which said supply chain data was requested if said server has not received said requested supply chain data after the expiry of said time limit.

The method may further include the step of said first trading entity specifying a plurality of said second trading entities sufficient to establish a complete supply chain.

In a further form, the invention resides in an apparatus for managing supply chain data in a supply chain date management system comprising a plurality of trading entities coupled to be in communication with said apparatus via a communications network, said apparatus comprising:
storage means for
a) registering a first trading entity as a participant of said system;
b) registering at least one second trading entity as a trading partner of said first trading entity;
c) storing a profile associated with each said trading entity, said profile specifying supply chain data to be communicated to and/or from one or more of said trading entities;
wherein, said apparatus automatically requests supply chain data from at least one of said trading entities and in response to receiving said requested supply chain data, said apparatus communicates data related to said supply chain data to one or more other of said trading entitles in accordance with their profile.

Preferably, said apparatus is an application server.

Suitably, the supply chain data is one or more of the following: estimated time of manufacture (ETM), arrival time and/or date (ARR), departures time and/or date (DEP), origin, destination, trading participant identity, mode of supply, customs clearance details (CCD), purchase order (PO), estimated time of supply (ETS), packing list (PL), shipper's letter of instruction (SLI), origin pick up details (OPU), house airway bill (HAWB), bill of lading (BOL), master airway bill (MAWB), ocean bill of lading (OBL), manifest details, freight and value (F/V) information, invoice, commercial invoice (CI), receipt of shipment (WR).

Further features of the present invention will become apparent from the following detailed description.

### BRIEF DESCRIPTION OF THE DRAWINGS

To assist in understanding the invention and to enable a person skilled in the art to put the invention into practical effect preferred embodiments of the invention will be described by way of example only with reference to the accompanying drawings, wherein:

FIG. 1 is a simplified schematic representation of the system according to the present invention;

FIG. 2 is a schematic representation of the system and some of the method steps according to one embodiment of the present invention;

FIG. 3 is a schematic representation of the method steps according to the present invention;

FIG. 4 is screenshot showing registration of a second trading entity as a trading partner of a first trading entity;

FIG. 5 is screenshot showing a group of registered second trading partners;

FIG. 6 is screenshot showing the creation of profiles for each registered trading partner;

FIG. 7 is screenshot showing purchase order information available to trading partners online; and

FIG. 8 is screenshot showing further purchase order information available to trading partners online.

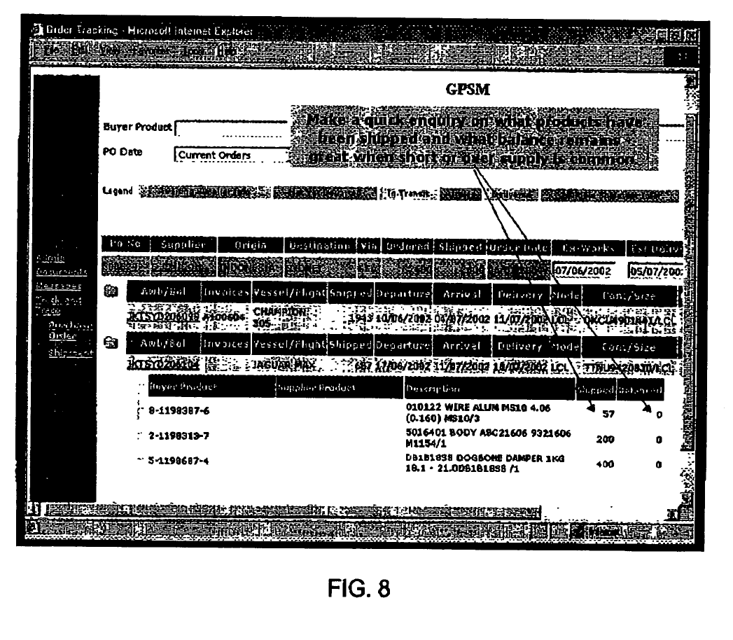

### DETAILED DESCRIPTION OF THE INVENTION

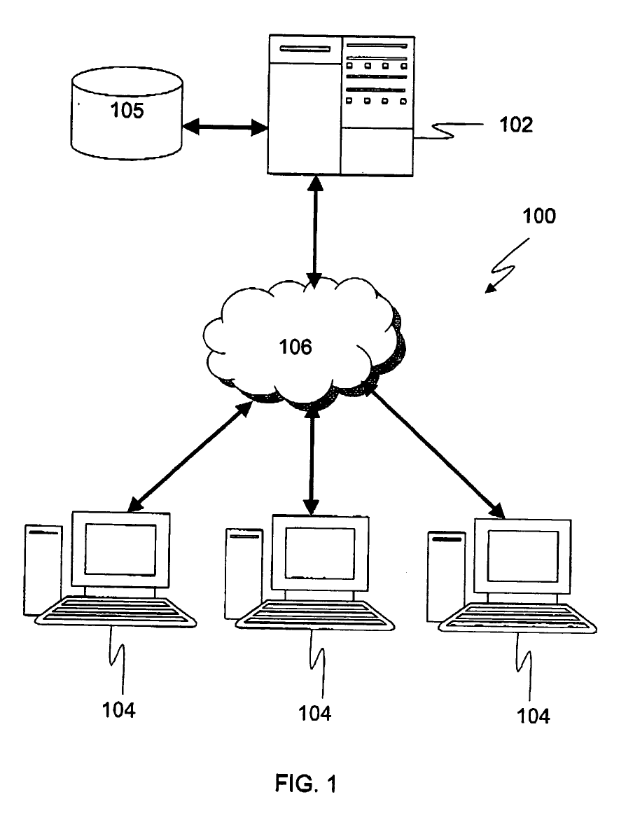

In the drawings, like numerals on different FIGS. are used to indicate like elements throughout. With reference to FIG. 1, the system 100 according to the present invention comprises trading entities 104 coupled to be in communication with an apparatus in the form of a server 102 over a communications network 106. The server 102 may be an application server or another type of suitable server known in the art. The communications network 106 could be the Internet, a local area network (LAN), an intranet, a virtual private network (VPN) or other suitable communications network known in the art, such as a wireless communications network. The server 102 is accessible in realtime by terminals of the trading entities 104 via an Internet browser installed on the terminals. Communication between trading entities and the server 102 may be via electronic mail (email) employing any conventional, suitable, secure communications protocol or via Electronic Data Interchange (EDI) technology, such as known X12 standards. Any known encryption technology may also be employed for improved communications security. The server also comprises, or is coupled to be in communication with, storage means 105 for storing the information required to perform the method as described herein.

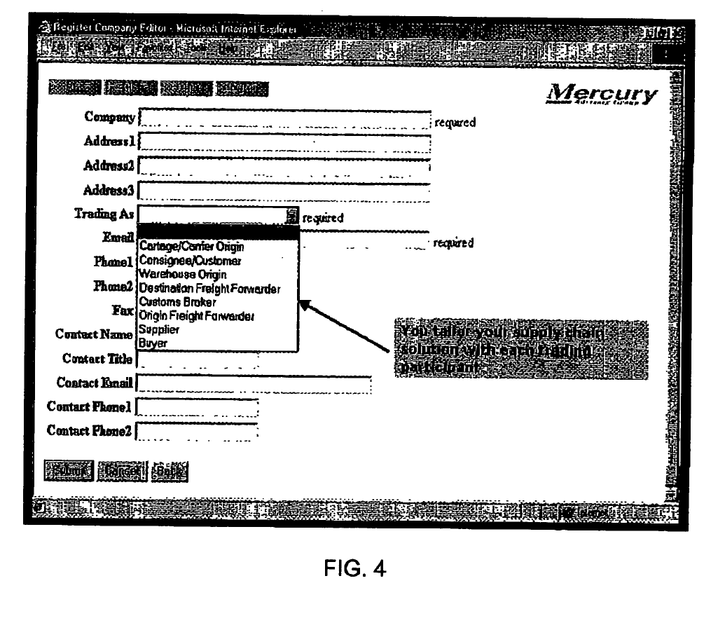

Once a first entity becomes a member of the system 100 via, for example, an online registration process, the first entity can then register details of one or more second trading entities in the form of their trading partners such as suppliers, manufacturers, delivery agents and the like, with the server 102 via the network 106. The first entity may fall into any category of business, such as a buyer, seller, manufacturer, shipping agent, warehouser or other trader. Registration of their trading partners may be carried out via the screen shown in FIG. 4. The server 102 automatically informs the trading partners via email or EDI that they have been included in the system as a trading partner of the first trading entity who registered them. The trading partners are also provided with a link to an online demonstration of the system to inform the trading partners about the system and to encourage them to join.

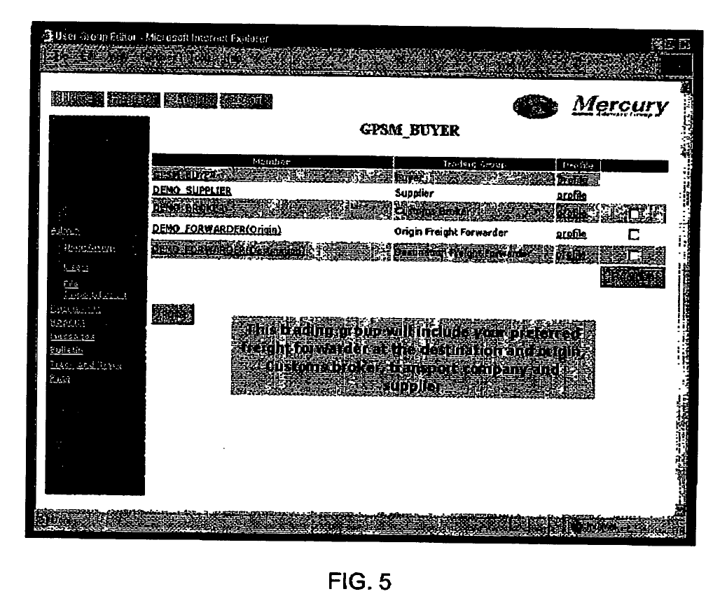

According to one example, a second trading partner in the form of a supplier may first be registered by the first trading entity as a trading partner of the first trading entity. Second trading entities in the form of origin freight forwarders, destination freight forwarders, customs brokers, customers and domestic carriers may then all be registered to create a trading or user group or group of trading relationships, as shown in FIG. 5.

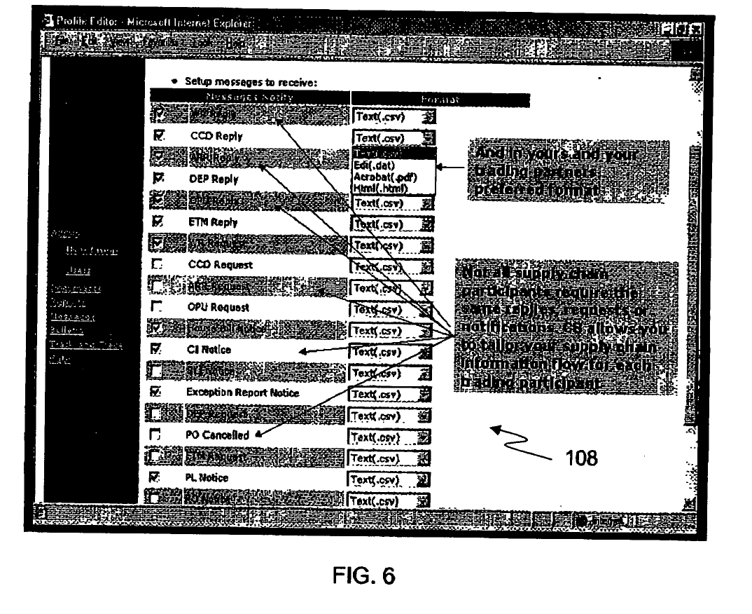

With reference to FIG. 6, a profile 108 for each trading partner within the group may then be individually created to determine the supply chain data that each trading partner will receive and be required to reply to, for example at each supply chain milestone. However, not all of the first trading entity's trading partners in their supply chain require the same replies, requests and/or notifications. Therefore, the system 100 of the present invention allows each first trading entity to tailor the supply chain information flow for each registered trading partner and to specify the preferred format in which the notifications, messages, reminders and the like are received, such as, but not limited to .csv, .dat, .pdf, .html. Creation of the profile 108 by the first trading entity may include specifying whether or not a trading partner receives a message requesting a reply containing certain information, such as a customs cleared (CCD) reply, an arrival time/date (ARR) and/or departure time/date (DEP) reply, and/or an estimated time of manufacture (ETM) reply.

The server 102 controls the sending and receiving of requests for and/or replies to information. Rather than trading entities having to search for information from websites or needing to call suppliers, manufacturers or the like, the server 102 transmits information via email or EDI directly to the first trading entities of the system 100 and their registered trading partners as soon as the information is available, depending on the profiles 108 of each trading entity.

Supply chain documents are accessible online from the server 102 to the first trading entity and any of their trading partners whom they wish to have access to the information, thus obviating the need for mailing, faxing or emailing documents to trading partners. Since trading partners know they will automatically receive updated information as soon as it is available, the trading partners do not waste time searching for information before it is available, which is a common problem in conventional supply chains.

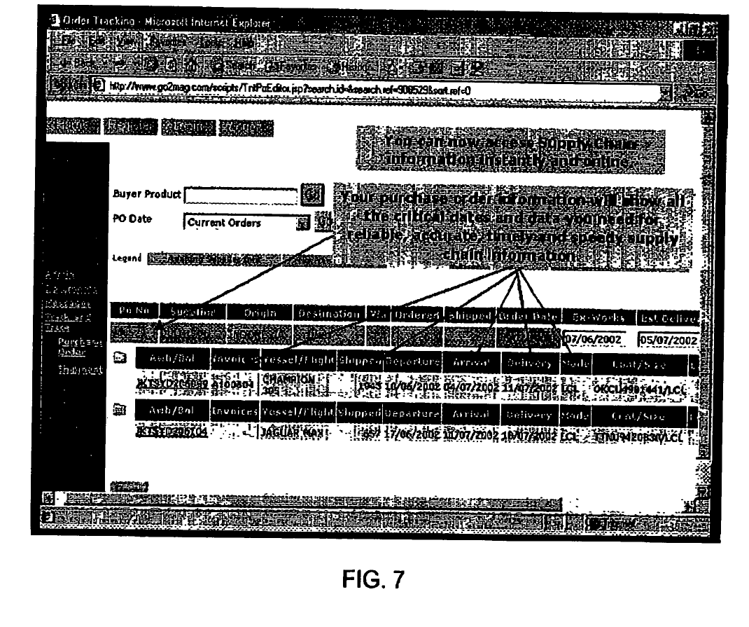

FIG. 7 shows an example of purchase order information that is accessible online by the relevant trading entities. The purchase order may include important information such as invoice numbers, departure and arrival dates, shipping information, quantities, product data and orders linked to shipments, which may also be linked to products. Ex-factory and delivery dates may be compared and enquiries on shipped quantities against remaining balances may easily be made, which is useful where short supply or over supply are common. The unit price of the shipped consignment may be compared against the unit price on the original order. Color-coding may be employed for the display of different areas of information for ease of reference. Searches may be carried out online on any item of information for reconciliation purposes and to link to shipments, purchase orders and the like. The system and method may also provide for freight and service provider fee checking with key performance indicator (KPI) reporting.

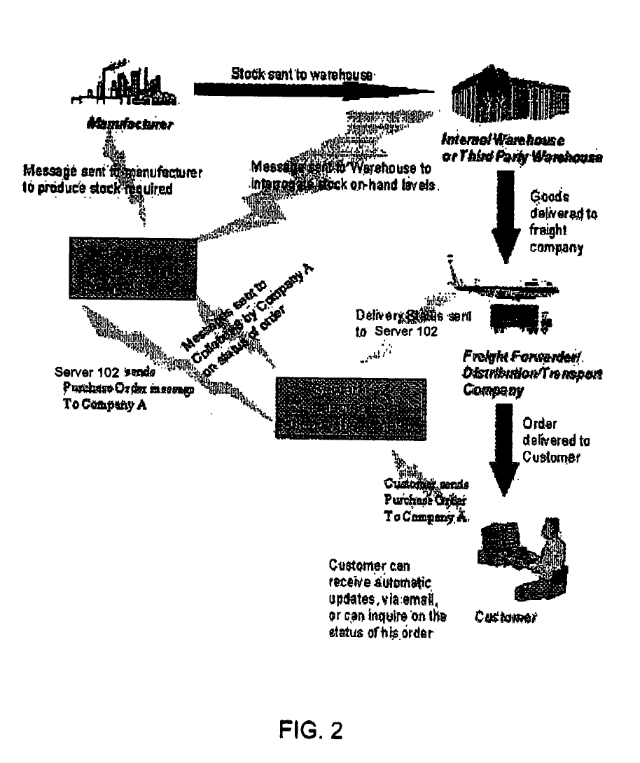

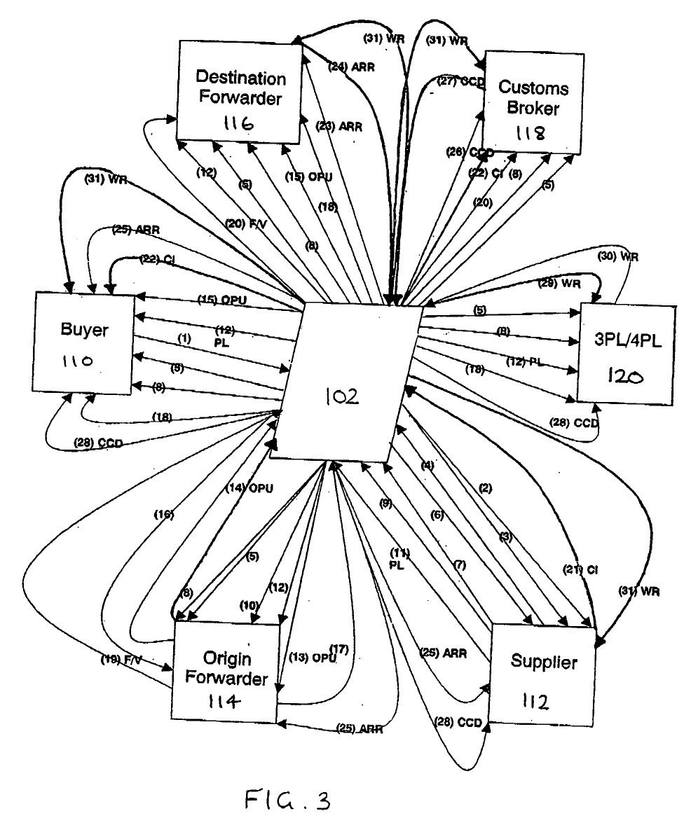

An embodiment of the method of the present invention will now be described with reference to the schematic overview shown in FIG. 2 and the more detailed representation of the method steps shown in FIG. 3. Referring to FIG. 2, the method of the present invention will be described with reference to a supply chain involving the ordering by a customer in a first country of a product from Company A in a second country via the server 102 for delivery to the customer. The supply chain includes communicating supply chain data to and from a manufacturer, an internal warehouse or third party warehouse (third party logistics), and a freight forwarder/distribution/transport company. However, it will be appreciated that the present invention is not limited to this scenario and that the present invention is applicable to a wide range of supply chains involving additional and/or alternative trading entities, whether the supply chain be domestic or international, whether for tangible products and/or the provision of services.

Step 1 represents a registered first trading entity of the system 100 in the form of a buyer 110 transmitting supply chain data in the form of a purchase order (PO) to the server 102. Transmission of the PO may be via email or EDI. Alternatively, details of the purchase order may be manually entered into the server 102, e.g. in the event of a system failure.

In step 2, a second trading entity of the system in the form of a supplier 112 that is registered as a trading partner of the buyer 110, receives the PO via email or EDI from the server 102. Alternatively, transmission of the PO to the supplier 112 may be via facsimile, e.g. In the event that the supplier 112 is not a registered trading entity of the system 100.

According to step 3, the server 102 transmits a message to the supplier 112 requesting an estimated time of manufacture (ETM) and/or an estimated time of supply (ETS). As represented by step 4, the supplier 112 replies to the request transmitted in step 3. A predetermined time limit for responding to the message sent by the server 102 may be associated with the request for information. The predetermined time limit may be, for example, 24 hours, 3 days or 5 days depending on the nature of the supply chain. In the absence of a response from the supplier 112, the server 102 may send a reminder.

If no response to the reminder is received, the failure to respond will be logged and participating trading entities, such as the first trading entity, will be informed, thus identifying weak links in the supply chain. The identification of such weaknesses to entitles enables participating trading entitles to informatively revise their trading groups and optimize their supply chain. This feature also encourages high standards of performance. Where no response to the reminder is received, an appointed administrator, such as a nominee of the buyer 102 or supplier 112, will be notified who can then remedy the absence of information.

As represented by the multiple steps 5, the server 102 transmits the information regarding the ETM and/or ETS (ETM/ETS update) received from the supplier 112 via email, EDI or fax to the trading partners registered by the first entity that initiated the trading relationships as described above. The trading partners who receive the ETM/ETS update will depend on the profile 108 created by the first trading entity. In FIG. 3, the ETM/ETS update is sent by the server 102 to the buyer 110 and other registered trading partners in the form of an origin forwarder 114, an destination forwarder 116, a customs broker 118 and third party and fourth party logistics (3PL/4PL) 120.

With reference to step 6, at a predetermined time before the estimated ETM/ETS provided by the supplier 112, the server 102 sends a request to the supplier 112 for a more accurate ETM/ETS than was provided in step 4. The predetermined time for this event may be, for example, 24 hours, 2 days or 5 days prior to the original estimated ETM/ETS provided by the supplier 112. In step 7, the supplier 112 responds to the request of step 6. In the absence of a response from supplier 112, a reminder may be sent to the supplier 112 by the server 102 as described above.

With reference to step 8, the updated ETM/ETS provided by the supplier 112 is then forwarded by email, EDI or fax by the server 102 to the trading partners if it is so specified in their profile 108 by the first trading entity to receive such an update. In the example shown in FIG. 3, the origin forwarder 114, destination forwarder 116, customs broker 118 and 3PL/4PL 120 all receive the updated ETM/ETS information.

When the product is manufactured and ready to be supplied, a shipper's letter of instruction (SLI) is transmitted by the supplier 112 via email, EDI or fax to the server 102, as represented by step 9. Alternatively, details of the SLI may be manually entered into the server 102.

In step 10, a message that the SLI has been received by the server 102 is forwarded by the server 102 by email, fax or EDI to the trading partners specified by the first trading entity in their profiles 108 to receive the message. In this example, only the origin forwarder 114 is specified as a recipient of the SLI update message. However, the buyer 110 may also be informed directly via an update that the SLI has been sent to the origin forwarder 114.

With reference to step 11, the supplier 112 transmits via email or EDI a packing list (PL) to the server 102. Alternatively, details of the PL may be manually entered into the server 102.

In step 12, the server 102 transmits by email, EDI or fax the PL information to the relevant trading partners. The first trading entity will have specified in the profile 108 of each trading participant whether that trading participant should receive the PL information. In this example and as shown in FIG. 3, the buyer 110, the origin forwarder 114, the destination forwarder 116 and 3PL/4PL 120 receive the PL information.

With reference to step 13, the server 102 prompts the origin forwarder 114 by email, EDI or fax for origin pick up details (OPU) based on the details provided by the supplier 112. The origin forwarder 114 then responds to the prompt by transmitting to the server 102 via by email, EDI or fax OPU details, as represented by step 14.

Depending on the profiles 108 created by the first trading entity for each trading participant, the relevant trading partners receive by email, EDI or fax the OPU information. As shown in FIG. 3, in this example the buyer 110 and the destination forwarder 116 receive the OPU information, which is transmitted by the server 102.

With reference to step 16, the server 102 then prompts the origin forwarder 114 by email, EDI or fax for transportation information, such as flight, courier, and/or shipping details. The prompt is responded to accordingly in step 17 by the origin forwarder 114 transmitting departure information (DEP) to the server 102.

In step 18, the server 102 transmits the DEP information to the trading partners whose profiles 108 specify that they should receive such information. In the example shown in FIG. 3, the buyer 110, destination forwarder 116 and 3PL/4PL 120 receive the DEP information.

Referring to step 19, transportation documentation information such as waybill information, such as house air waybill (HAWB) or bill of lading (BOL) details, master air waybill (MAWB) or ocean bill of lading (OBL) details and/or manifest details, and/or freight and value (F/V) information are emailed, faxed or transmitted via EDI by the origin forwarder 114 to the server 102. Alternatively, such information may be manually entered in to the server 102.

In step 20, the transportation documentation information is transmitted via email, EDI or fax by the server 102 to the predetermined trading partners as specified in their profiles 108 by the first trading entity. In this example, the destination forwarder 116 and the customs broker 118 receive the transportation documentation information.

With reference to step 21, a commercial invoice (CI) is transmitted by the supplier 112 to the server 102 via the communication network 106 via email or EDI. Alternatively, the CI information is entered manually into the server 102.

In step 22, the CI information is transmitted by the server 102 via email, EDI or fax to the predetermined trading partners as specified in their profiles 108 by the first trading entity. In this example, the buyer 110 and customs broker 118 receive the CI information.

Referring to step 23, the server 102 prompts the destination forwarder 116 via email, EDI or fax for shipment arrival details (ARR). In step 24, the destination forwarder 116 responds to step 23 by transmitting the ARR information by email, EDI or fax to the server 102. In the absence of a response to step 23 within a predetermined time frame, one or more reminders may be generated by the server 102.

With reference to step 25, the ARR details are forwarded by the server 102 to the registered trading partners specified by the first trading entity in the profiles 108 of each registered trading participant to receive such information. In this example, the ARR details are only forwarded to the buyer 110.

Referring to step 26, the server 102 prompts the customs broker 118 via email, EDI or fax for customs clearance and delivery details (CCD) of the shipment. In step 27, the customs broker 118 responds to step 26 by transmitting the CCD information by email, EDI or fax to the server 102. In the absence of a response to step 26 within a predetermined time frame, one or more reminders may be generated by the server 102.

With reference to step 28, the CCD details are forwarded by the server 102 to the registered trading partners specified by the first trading entity in the profiles 108 of each registered trading participant to receive such information. In this example, the CCD details are forwarded to the buyer 110, the supplier 112 and 3PL/4PL 120.

Referring to step 29, the server 102 prompts 3PL/4PL 120 via email, EDI or fax for receipt (WR) of shipment. In step 30, 3PL/4PL 120 responds to step 29 by transmitting the WR information by email, EDI or fax to the server 102. In the absence of a response to step 29 within a predetermined time frame, one or more reminders may be generated by the server 102.

With reference to steps 31, the WR details are forwarded by the server 102 to the registered trading partners specified by the first trading entity in the profiles 108 of each registered trading participant to receive such information. In this example, the WR details are forwarded to the buyer 110, the supplier 112, the destination forwarder 116 and the customs broker 118.

In the method described above, where messages are forwarded by the server, this may involve forwarding exactly the supply chain data received from a trading participant, forwarding a subset of the supply chain data received or forwarding a message confirming a particular action, time, date or the like. Hence, the supply chain data or data related to the supply chain data may be transmitted.

The method and system of the present invention thus provide a solution to the problem of inefficient and onerous supply chain data management by providing a central server, which receives, requests and re-routes critical supply chain data to and from trading partners within the system according to the algorithm described herein. Reminders and updates are sent automatically by the server to the relevant trading partners who require the information. Profiles for each trading participant are created by the first trading entity such that each trading partner receives only the supply chain data that it requires and does not receive superfluous information.

Moreover, the system and method of the present invention provides the aforementioned solution even if trading entities have not yet themselves registered with the server. Since the first trading entity has registered at least contact details of their trading partners with the server and created their profiles 108, supply chain data may be requested and received from the trading partners, reminders sent and information forwarded and the like via email or EDI. Hence, the supply chain data management system and method of the present invention still effectively and efficiently manage the supply chain data without the need to wait for trading partners to adopt a new system.

The system and method is not limited to any maximum number of trading entities, supply chains or the complexity thereof. Therefore, the system and method of the present invention can vastly simplify complex supply chains and thus make them transparent whilst reducing inventory costs, increasing efficiency, productivity, communication quality and certainty, reducing dislocation between trading entities and improving customer satisfaction. The server 102 is also independent of all the trading entitles in the supply chain of the system 100.

Furthermore, since most businesses already have at least email capability as a function of their internal systems, which is the minimum requirement to communicate directly with the server 102, no new software or hardware is required to implement the system and method of the present invention, thus avoiding unnecessary expenditure and addressing another problem associated with the prior art. Rather than paying for an entirely new system or expensive software upgrades, the only expenditure may be a minimal initial subscription and a small fee per transaction. Additionally, since most users are already familiar with email, which is easy to use, there is no delay whilst users become familiar with the system and method and the system itself is easy to use.

The Applicants envisage that the system, method and apparatus of the present invention have a wide range of possible applications in view of communication and supply being the backbone of, not only modern business, but other fields of activity, such as humanitarian projects, military projects and campaigns, domestic supply chains and national and international governmental logistics.

Throughout the specification the aim has been to describe the invention without limiting the invention to any one embodiment or specific collection of features. Persons skilled in the relevant art may realize variations from the specific embodiments that will nonetheless fall within the scope of the invention.

1. A supply chain data management system comprising:
a first trading entity coupled to be in communication with a server via a communications network, said first trading entity registered with said server as a participant of said system;
at least one second trading entity coupled to be in communication with said server via said communications network, said at least one second trading entity registered by said first trading entity as a trading partner of said first trading entity;
a profile associated with each said trading entity, said profile specifying supply chain data to be communicated to and/or from one or more of said trading entities, each profile accessible by said server;
wherein, said server automatically requests supply chain data from at least one of said trading entitles and in response to receiving said requested supply chain data, said server communicates data related to said supply chain data to one or more other trading entities in accordance with their profile.

2. The system of claim 1, wherein each profile for each said second trading entity registered as a trading partner of said first trading entity is created by said first trading entity.

3. The system of claim 1, wherein said server informs said second trading entity via said communications network that they have been registered by said first trading entity following registration of said second trading entity by said first trading entity.

4. The system of claim 1, wherein each profile specifies a format of the supply chain data to be communicated to and/or from said trading entity.

5. The system of claim 1, wherein a predetermined time limit for responding to said request for supply chain data is associated with said request, after the expiry of which, if said server has not received said requested supply chain data, a reminder is sent by said server to said trading entity from which said supply chain data was requested.

6. The system of claim 1, wherein said data related to said supply chain data comprises a notification that supply chain data is available via said communications network, the availability of said data to said one or more of said second trading entities being specified by said first trading entity in said profile of said second trading entities.

7. The system of claim 1, wherein said supply chain data is communicated by one or more of the following: email, electronic data interchange (EDI), facsimile.

8. The system of claim 1, wherein said supply chain data is one or more of the following: estimated time of manufacture (ETM), arrival time and/or date (ARR), departures time and/or date (DEP), origin, destination, trading participant identity, mode of supply, customs clearance details (CCD), purchase order (PO), estimated time of supply (ETS), pacing list (PL), shippers letter of instruction (SLI), origin pick up details (OPU), house airway bill (HAWB), bill of lading (BOL), master airway bill (MAWB), ocean bill of lading (OBL), manifest details, freight and value (F/V) information, invoice, commercial invoice (CI), receipt of shipment (WR).

9. The system of claim 1, wherein said server is an application server.

10. A method of managing supply chain data in a system comprising a plurality of trading entitles coupled to be in communication with a server via a communications network, said method including the steps of:
registering with said server at least one second trading entity as a trading partner of a first trading entity,
creating a profile associated with each said trading entity, each said profile specifying supply chain data to be communicated to and/or from one or more of said trading entities, each profile accessible by said server;
automatically requesting supply chain data from at least one of said trading entities; and
in response to said server receiving said requested supply chain data, communicating data related to said supply chain data to one or more other of said trading entities in accordance with their profile.

11. The method of claim 10, further including the step of specifying a format in which each trading entity receives said data related to said supply chain.

12. The method of claim 10, further including the step of said server informing said second trading entity via said communications network that they have been registered as a trading partner of said first trading entity by said first trading entity.

13. The method of claim 10, further including the steps of:
specifying a predetermined time limit for responding to said request for supply chain data; and
sending a reminder from said server to said trading entity from which said supply chain data was requested if said server has not received said requested supply chain data after the expiry of said time limit.

14. The method of claim 10, further including the step of said first trading entity specifying a plurality of said second trading entities sufficient to establish a complete supply chain.

15. An apparatus for managing supply chain data in a supply chain data management system comprising a plurality of trading entities coupled to be in communication with said apparatus via a communications network, said apparatus comprising:
storage means for
a) registering a first trading entity as a participant of said system;
b) registering at least one second trading entity as a trading partner of said first trading entity;
c) storing a profile associated with each said trading entity, said profile specifying supply chain data to be communicated to and/or from one or more of said trading entities;
wherein, said apparatus automatically requests supply chain data from at least one of said trading entities and in response to receiving said requested supply chain data, said apparatus communicates data related to said supply chain data to one or more other of said trading entities in accordance with their profile.

16. The apparatus of claim 15, wherein each profile specifies a format of the supply chain data to be communicated to and/or from said trading entity.

17. The apparatus of claim 15, wherein said supply chain data is one or more of the following: estimated time of manufacture (ETM), arrival time and/or date (ARR), departures time and/or date (DEP), customs clearance details (CCD), purchase order (PO), estimated time of supply (ETS), packing list (PL), shipper's letter of instruction (SLI), origin pick up details (OPU), house airway bill (HAWB), bill of lading (BOL), master airway bill (MAWB), ocean bill of lading (OBL), manifest details, freight and value (F/V) information, invoice, commercial invoice (CI), receipt of shipment (WR).
